(19) United States
(12) Patent Application Publication
(10) Pub. No.: US 2026/0295826 A1
(43) Pub. Date: Oct. 1, 2026

(54) ROBOT SYSTEM, METHOD FOR CONTROLLING ROBOT SYSTEM, AND STORAGE MEDIUM

(71) Applicant: KAWASAKI JUKOGYO KABUSHIKI KAISHA, Kobe-shi (JP)

(72) Inventors: Tomomichi ARIGA, Kobe-shi (JP); Hisashi MORIYAMA, Kobe-shi (JP)

(73) Assignee: KAWASAKI JUKOGYO KABUSHIKI KAISHA, Kobe-shi (JP)

(21) Appl. No.: 19/632,687

(22) Filed: Mar. 30, 2026

(30) Foreign Application Priority Data
Mar. 28, 2025 (JP) 2025-056218

(51) Int. Cl. B25J 9/16; B25J 19/00

(52) U.S. Cl. CPC B25J 9/1633; B25J 9/1651; B25J 19/0004

(57) ABSTRACT

A robot system according to this disclosure includes a controller configured to, when operating a robot, control a drive shaft by torque control, and, when stopping the robot, switch control of the drive shaft from torque control to velocity control and decelerate the drive shaft by the velocity control to hold a command value of the velocity control at zero so as to maintain a posture of the stopped robot.

### CROSS-REFERENCE TO RELATED APPLICATION

The priority application number JP2025-056218, a robot system, a method for controlling a robot system, and a control program for a robot system, filed on Mar. 28, 2025, Ariga Tomomichi, and Moriyama Hisashi, upon which this patent application is based, are hereby incorporated by reference.

### BACKGROUND OF THE INVENTION

### Field of the Invention

The present disclosure relates to a robot system, a method for controlling a robot system, and a storage medium.

### Description of the Background Art

A robot system including a robot is known in the art. For example, such a robot system including a robot is disclosed in Japanese Patent Laid-Open Publication No. JP H04-283087. The robot includes a robot mechanism portion to which a servo motor and a brake are attached. The robot system is configured such that, when the robot is stopped, the robot is braked and a servo power supply is cut off.

Here, when a robot controlled by torque control is stopped and operation of the robot by torque control is restarted, a user may input a command value for torque control when restarting the operation of the robot by torque control. However, in the robot system disclosed in Japanese Patent Laid-Open Publication No. JP H04-283087, when the robot is stopped, the robot is braked and the servo power supply is cut off, and, accordingly, the torque value of the robot becomes zero. In this case, the user needs to calculate, from the posture of the stopped robot or the like, the command value for torque control to be input when restarting the operation of the robot by torque control, and, as a result, it is difficult to smoothly restart the operation of the robot by torque control. For this reason, it is desired to smoothly restart the operation of a robot by torque control after the robot controlled by torque control has been stopped.

### SUMMARY OF THE INVENTION

The present disclosure is intended to solve the above problem, and one object of the present disclosure is to provide a robot system, a method for controlling a robot system, and a storage medium capable of smoothly restarting operation of a robot under torque control after the robot controlled by torque control has been stopped.

In order to attain the aforementioned object, a robot system according to a first aspect includes a robot including a drive shaft, and a controller configured to control the robot, wherein the controller is configured to, when operating the robot, control the drive shaft by torque control, and, when stopping the robot, switch control of the drive shaft from the torque control to velocity control and decelerate the drive shaft by the velocity control to hold a command value of the velocity control at zero so as to maintain a posture of the stopped robot.

In the robot system according to the first aspect, as discussed above, the controller is configured to, when stopping the robot, switch control of the drive shaft from the torque control to velocity control and decelerate the drive shaft by the velocity control to hold a command value of the velocity control at zero so as to maintain a posture of the stopped robot. Accordingly, since the robot can be stopped while torque is generated in the drive shaft, a user can grasp a torque value of the drive shaft when the robot is stopped. As a result, the user can grasp a command value for torque control to be input when restarting operation of the robot by torque control, and does not need to calculate the command value for torque control to be input when restarting operation of the robot by torque control. Therefore, it is possible to smoothly restart operation of the robot by torque control after the robot controlled by torque control has been stopped.

In order to attain the aforementioned object, a method for controlling a robot system according to a second aspect includes controlling a drive shaft of a robot by torque control when operating the robot; switching control of the drive shaft from the torque control to velocity control when stopping the robot; and decelerating the drive shaft by the velocity control and maintaining a posture of the stopped robot by holding a command value of the velocity control at zero.

In the method for controlling a robot system according to the second aspect, as discussed above, switching control of the drive shaft from the torque control to velocity control when stopping the robot; and decelerating the drive shaft by the velocity control and maintaining a posture of the stopped robot by holding a command value of the velocity control at zero are provided. Accordingly, since the robot can be stopped while torque is generated in the drive shaft, a user can grasp a torque value of the drive shaft when the robot is stopped. As a result, the user can grasp a command value for torque control to be input when restarting operation of the robot by torque control, and does not need to calculate the command value for torque control to be input when restarting operation of the robot by torque control. Therefore, it is possible to provide a method for controlling a robot system capable of smoothly restarting operation of a robot by torque control after the robot controlled by torque control has been stopped.

In order to attain the aforementioned object, a storage medium for storing a program for controlling a robot system according to a third aspect causes a computer to execute processing for controlling a drive shaft of a robot by torque control when operating the robot; processing for switching control of the drive shaft from the torque control to velocity control when stopping the robot; and processing for decelerating the drive shaft by the velocity control and maintaining a posture of the stopped robot by holding a command value of the velocity control at zero.

In the storage medium for storing the program for controlling a robot system according to the third aspect, as discussed above, the computer is caused to execute processing for switching control of the drive shaft from the torque control to velocity control when stopping the robot; and processing for decelerating the drive shaft by the velocity control and maintaining a posture of the stopped robot by holding a command value of the velocity control at zero. Accordingly, since the robot can be stopped while torque is generated in the drive shaft, a user can grasp a torque value of the drive shaft when the robot is stopped. As a result, the user can grasp a command value for torque control to be input when restarting operation of the robot by torque control, and does not need to calculate the command value for torque control to be input when restarting operation of the robot by torque control. Therefore, it is possible to provide a program for controlling a robot system capable of smoothly restarting operation of a robot by torque control after the robot controlled by torque control has been stopped.

According to the present disclosure, as discussed above, it is possible to smoothly restart operation of the robot by torque control after the robot controlled by torque control has been stopped.

### BRIEF DESCRIPTION OF THE DRAWINGS

FIG. 1 is a diagram showing a robot system according to one embodiment.

FIG. 2 is a block diagram of the robot system according to one embodiment.

FIG. 3 is a diagram for illustrating a control loop for controlling operation of a robot in the robot system according to one embodiment.

FIG. 4 is a time chart for illustrating a temporary stop of the robot in the robot system according to one embodiment.

FIG. 5 is a time chart for illustrating an emergency stop of the robot in the robot system according to one embodiment.

FIG. 6 is a flowchart for illustrating control processing of the robot system according to one embodiment.

FIG. 7 is a diagram for illustrating a robot and an end effector according to one embodiment.

FIG. 8 is a diagram for illustrating a robot and a position changer according to one embodiment.

### DESCRIPTION OF THE PREFERRED EMBODIMENT

The following description describes a configuration of a robot system 100 according to one embodiment.

### Configuration of Robot System

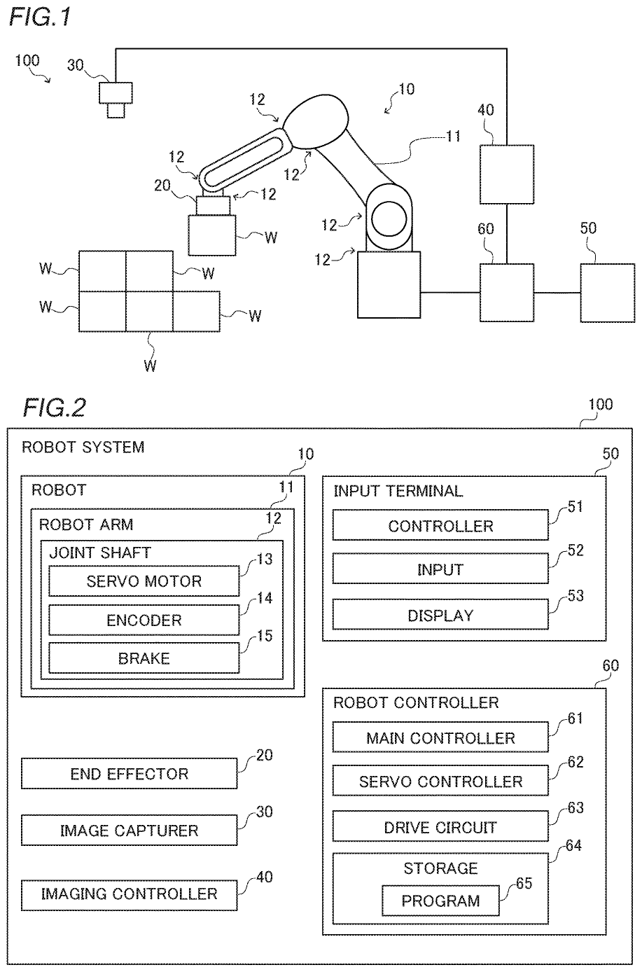

As shown in FIG. 1, the robot system 100 is a system that conveys a workpiece W by a robot 10. The robot 10 is, for example, a logistics robot. The workpiece W is, for example, a cardboard case or a plastic case. A plurality of workpieces W are provided. The workpieces W may be stacked or may not be stacked. The robot system 100 sequentially conveys the workpieces W from one place to another place by the robot 10.

As shown in FIGS. 1 and 2, the robot system 100 includes the robot 10, an end effector 20, an image capturer 30, an imaging controller 40, an input terminal 50, and a robot controller 60. The robot controller 60 is an example of a controller and a computer.

The robot 10 is an industrial robot. The robot 10 is, for example, a vertical multi-joint robot. The robot 10 can be controlled by torque control for controlling the robot 10 using a torque command value, velocity control for controlling the robot 10 using a velocity command value, and position control for controlling the robot 10 using a position command value.

The robot 10 includes a robot arm 11. The robot arm 11 includes a plurality of joint shafts 12 as drive shafts. For example, when the robot 10 is a six-axis vertical multi-joint robot, the number of the joint shafts 12 is six. The joint shafts 12 are rotational joints. A servo motor 13, an encoder 14, and a brake 15 are arranged at each of the joint shafts 12. The joint shaft 12 is an example of a drive shaft.

The servo motor 13 is a drive source for driving the robot arm 11. The servo motor 13 rotates when electric power is supplied. For example, a rotating shaft of the servo motor 13 is driven by three-phase AC power. The encoder 14 detects a rotation angle of the servo motor 13. The encoder 14 outputs, to the robot controller 60, a detection value indicating the detected rotation angle of the servo motor 13. The brake 15 brakes movement of the robot arm 11. The brake 15 is, for example, an electromagnetic brake such as a fail-safe brake. The brake 15 may be configured to be used in combination with a dynamic brake.

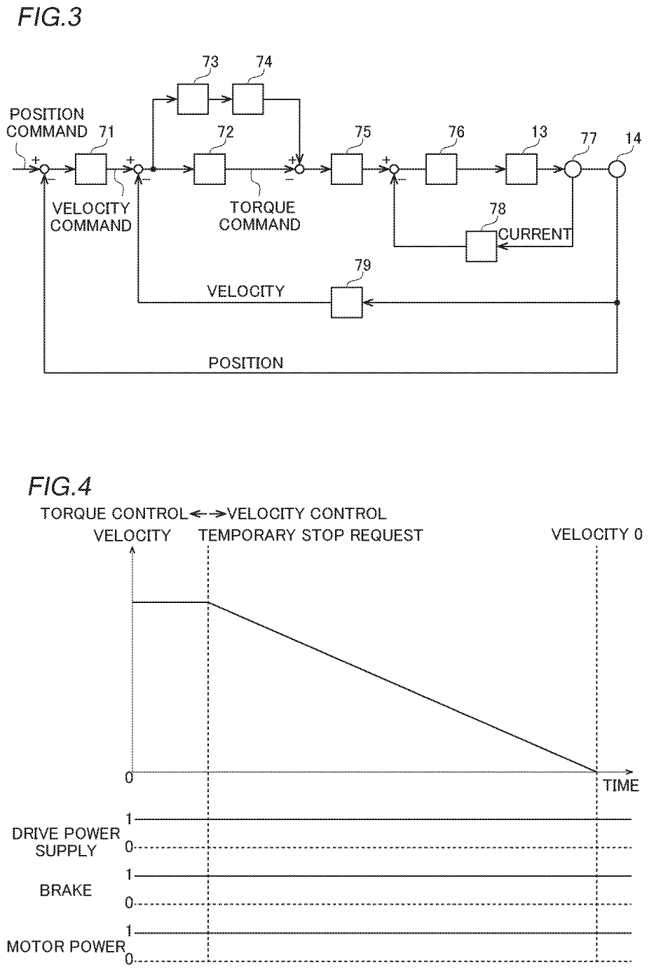

FIG. 3 shows a control loop for controlling operation of the robot 10. The control loop includes a position control loop, a velocity control loop, and a torque control loop. In the position control loop, with respect to a command value for position control, an output value of the encoder 14 is fed back and input to a position control gain circuit 71. A gain for position control is multiplied by the input value of the position control gain circuit 71, and the resulting value is output as a command value for velocity control. In the velocity control loop, with respect to a command value for velocity control, a velocity value acquired by differentiating the output value of the encoder 14 by a differentiator 79 is fed back and input to a velocity control gain circuit 72 and an integrator 73. A gain for velocity control is multiplied by the input value of the velocity control gain circuit 72, and the resulting value is output as a command value for torque control. The command value for torque control is a command value for current. Further, an integrated value acquired by integrating the input value of the integrator 73 is input to a torque limiter 74.

An output value of the velocity control gain circuit 72 is subtracted from an output value limited by the torque limiter 74, and the resulting value is input to the torque controller 75. In the torque control loop, with respect to the output value of the torque controller 75, a current value acquired by adjusting an output value of the current detector 77 by a current feedback gain circuit 78 is fed back, and a command value for current is acquired. Based on the acquired command value for current, a current is supplied to the servo motor 13 by the servo amplifier 76. Elements constituting the control loop, such as the position control gain circuit 71, the velocity control gain circuit 72, the integrator 73, the torque limiter 74, the torque controller 75, the servo amplifier 76, the current detector 77, the current feedback gain circuit 78, and the differentiator 79, are provided in the robot controller 60. The robot controller 60 executes the control loop. The robot controller 60 can execute the control loop individually for each of the joint shafts 12.

As shown in FIGS. 1 and 2, the end effector 20 is arranged at a distal end of the robot arm 11. The end effector 20 is, for example, a robot hand that holds the workpiece W.

The image capturer 30 captures an image of the workpiece W. The image capturer 30 outputs an image of the captured workpiece W to the imaging controller 40. The image capturer 30 is a camera including a solid-state imaging device such as a CMOS image sensor or a CCD image sensor. The image capturer 30 is arranged independently of the robot 10. The image capturer 30 may be arranged on the robot 10.

The imaging controller 40 acquires the image of the workpiece W captured by the image capturer 30, and calculates position information regarding a position of the workpiece W based on the acquired image. The imaging controller 40 outputs the calculated position information to the robot controller 60. The imaging controller 40 includes, for example, a processor such as a GPU and a memory that stores information.

The input terminal 50 receives an input of a command from a user. The input terminal 50 outputs the received command to the robot controller 60. The input terminal 50 includes a controller 51, an input 52, and a display 53. The controller 51 controls respective components of the input terminal 50. The controller 51 includes a processor such as a CPU and a memory that stores information. The input 52 receives an input operation of a command from the user. The input 52 includes buttons, keys, a touch panel, and the like. The display 53 displays various types of information. The display 53 includes a display device such as a liquid crystal display or an organic EL display.

The robot controller 60 controls the robot 10. Specifically, the robot controller 60 controls a conveying operation of the workpiece W using the end effector 20 by the robot 10. More specifically, the robot controller 60 controls the conveying operation of the workpiece W using the end effector 20 by the robot 10 based on position information of the workpiece W acquired from the imaging controller 40 and command information from the user acquired from the input terminal 50.

The robot controller 60 includes a main controller 61, a servo controller 62, a drive circuit 63, and a storage 64. The main controller 61 controls rotational operations of each of the joint shafts 12 of the robot arm 11. The servo controller 62 controls a drive current output to the servo motor 13 that serves as a drive source for operating the robot arm 11 based on a command from the main controller 61. The drive circuit 63 supplies drive power to each of the joint shafts 12. The drive circuit 63 includes an inverter circuit that supplies alternating current power to the servo motor 13. The drive circuit 63 includes the servo amplifier 76. The drive circuit 63 is provided for each joint shaft 12. Each of the main controller 61 and the servo controller 62 includes a processor such as a CPU and a memory that stores information.

The storage 64 includes, for example, a non-volatile memory such as a hard disk drive, and stores a program 65 executed by the robot controller 60. The storage 64 is a computer-readable non-transitory tangible recording medium. The program 65 may be installed in the storage 64 from a recording medium for supplying the program 65, such as a hard disk drive, a semiconductor memory, an optical disk, or a magneto-optical disk. The recording medium for supplying the program 65 is a computer-readable non-transitory tangible recording medium. The program 65 may be distributed via a network for supplying the program 65 and installed in the storage 64. The program 65 is an example of a program for controlling a robot system. By executing the program 65, the robot controller 60 functions as a computer that performs control of this embodiment.

### Control of Robot

When operating the robot 10, the robot controller 60 controls the joint shafts 12 by torque control. Specifically, when the robot 10 performs a conveying operation of the workpiece W, the robot controller 60 controls the joint shafts 12 by torque control. The user inputs a torque command value using the input 52 of the input terminal 50 so that the robot 10 performs the conveying operation of the workpiece W with a desired torque. The robot controller 60 acquires the torque command value input by the user from the input terminal 50, and controls the joint shafts 12 by torque control based on the acquired torque command value. In addition to the torque control, at least one of position control or velocity control may be performed.

Here, in the present embodiment, as shown in FIG. 4, when stopping the robot 10, the robot controller 60 switches control of the joint shafts 12 from torque control to velocity control and decelerates the joint shafts 12 by the velocity control to hold command values of the velocity control of the joint shafts 12 at zero so as to maintain a posture of the stopped robot 10. Specifically, the robot controller 60 performs control to maintain a posture of the stopped robot 10 by holding command values of velocity control for all of the joint shafts 12 at zero. That is, the control shown in FIG. 4 is performed for all of the joint shafts 12. When stopping the robot 10, the robot controller 60 controls the joint shafts 12 only by velocity control. Further, the robot controller 60 performs control to gradually decrease command values of the velocity control until the command values reach zero so that the joint shafts 12 are gradually decelerated at a predetermined fixed deceleration rate. After the command values of the velocity control have been decreased to zero, the robot controller 60 performs control to hold the command values of the velocity control at zero. That is, the robot controller 60 controls drive currents of the servo motors 13 of the joint shafts 12 so as not to move the joint shafts 12. The robot 10 does not have a predetermined stopping posture, and the posture of the stopped robot 10 varies depending on an operation immediately before the robot 10 stops. Accordingly, depending on the posture of the stopped robot 10, the plurality of joint shafts 12 may tend to move due to gravity or the like; however, by holding the command values of the velocity control at zero, the joint shafts 12 are prevented from moving, and as a result the posture of the stopped robot 10 is maintained.

Further, in this embodiment, the robot controller 60 maintains the brake 15 in a released state while maintaining the posture of the stopped robot 10 by holding the command values of the velocity control at zero. That is, the robot controller 60 does not apply the brake 15 even when stopping the robot 10. The robot controller 60 maintains the brake 15 in a released state both when operating the robot 10 and when stopping the robot 10. When the brake 15 is a fail-safe brake, the robot controller 60 maintains the brake 15 in a released state by maintaining energization of the brake 15. In FIG. 4, in “Brake”, “1” indicates that the brake 15 is in a released state, and “0” indicates that the brake 15 is in an applied state.

Further, in this embodiment, the robot controller 60 maintains a state in which power is supplied to the joint shafts 12 while maintaining the posture of the stopped robot 10 by holding command values of the velocity control at zero. That is, the robot controller 60 does not stop supplying power to the joint shafts 12 even when stopping the robot 10. The robot controller 60 maintains a state in which power is supplied to the joint shafts 12 both when operating the robot 10 and when stopping the robot 10.

Here, a power system of the robot controller 60 is divided into a control system that supplies control power to the main controller 61, the servo controller 62 and the like, and a drive system that supplies drive power for driving the servo motor 13 to the drive circuit 63 and the like. The control system includes a control power supply line that supplies control power from an IPM gate power supply to the inverter circuit of the drive circuit 63 for turning on and off switches of the inverter circuit. Further, the control power supply line includes a switch for turning on and off supply of power, such as a semiconductor switch. The robot controller 60 maintains a state in which power is supplied to the joint shafts 12 by maintaining the switch of the control power supply line in an on state without turning off the switch, thereby maintaining supply of drive power to the drive circuit 63 and the servo motor 13.

Further, the drive system includes a drive power supply line that supplies drive power from a commercial power supply to the drive circuit 63. In some cases, the drive power supply line is provided with a switch for turning on and off supply of power, such as a magnetic contactor or a semiconductor switch. In such a case, the robot controller 60 may maintain a state in which power is supplied to the joint shafts 12 by maintaining the switch of the drive power supply line in an on state without turning off the switch, thereby maintaining supply of drive power to the drive circuit 63 and the servo motor 13. In FIG. 4, in “Drive Power Supply”, “1” indicates a state in which power is supplied to the drive circuit 63, and “0” indicates a state in which power is not supplied to the drive circuit 63. Further, in FIG. 4, in “Motor”, “1” indicates a state in which power is supplied to the servo motor 13, and “0” indicates a state in which power is not supplied to the servo motor 13.

Further, in this embodiment, the robot controller 60 provides torque values of the joint shafts 12 in a state in which the posture of the stopped robot 10 is maintained by holding command values of the velocity control at zero. Specifically, the robot controller 60 transmits the torque values of the joint shafts 12 to the input terminal 50. The controller 51 of the input terminal 50 displays the torque values of the plurality of joint shafts 12 on the display 53 based on an input operation by the user using the input 52 for displaying the torque values of the plurality of joint shafts 12. Accordingly, the user can check the torque values of the joint shafts 12 in a state in which the posture of the stopped robot 10 is maintained. The robot controller 60 may be configured to periodically output torque values, speeds, positions, and the like of the plurality of joint shafts 12 to the input terminal 50.

Further, in this embodiment, in a state in which the posture of the stopped robot 10 is maintained by holding command values of the velocity control at zero, when receiving an input of command values of torque control for the plurality of joint shafts 12 for restarting operation of the robot 10, the robot controller 60 switches control of the joint shafts 12 from velocity control to torque control so as to restart operation of the robot 10. After the robot 10 is stopped, when restarting operation of the robot 10, the user inputs command values of torque control for the joint shafts 12 for restarting operation of the robot 10 using the input 52 of the input terminal 50. In this case, the user inputs, as command values of torque control, torque values of the plurality of joint shafts 12 in a state in which the posture of the stopped robot 10 is maintained, the torque values displayed on the display 53 of the input terminal 50 and checked by the user. The robot controller 60 acquires the command values of torque control input by the user from the input terminal 50, and restarts operation of the robot 10 based on the acquired command values of torque control. When not only torque control but also at least one of position control or velocity control is performed, operation of the robot 10 by torque control and by at least one of position control or velocity control is restarted.

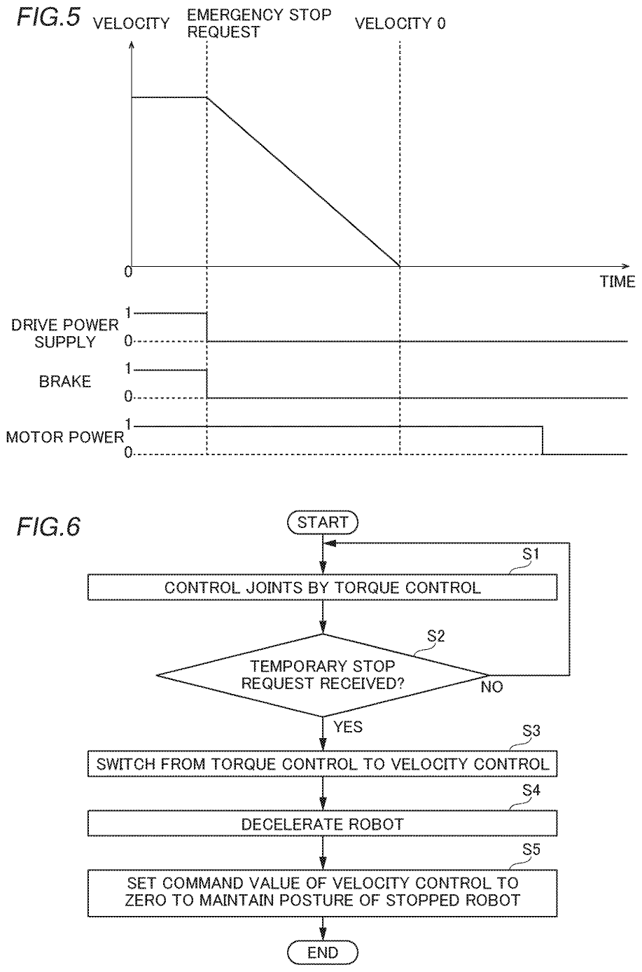

Further, in this embodiment, as shown in FIGS. 4 and 5, when performing a temporary stop of the robot 10, the robot controller 60 maintains the posture of the stopped robot 10 by holding command values of velocity control at zero without applying the brake 15, and, when performing an emergency stop of the robot 10, applies the brake 15 to maintain the posture of the stopped robot 10. Specifically, the controller 51 of the input terminal 50 transmits, from the input terminal 50 to the robot controller 60, a temporary stop request for performing a temporary stop of the robot 10 based on an input operation by the user using the input 52 to perform a temporary stop of the robot 10. When the robot controller 60 receives the temporary stop request from the controller 51, the robot controller 60 maintains the posture of the stopped robot 10 by holding command values of velocity control at zero without applying the brake 15.

On the other hand, the controller 51 of the input terminal 50 transmits, from the input terminal 50 to the robot controller 60, an emergency stop request for performing an emergency stop of the robot 10 based on an input operation by the user using the input 52 to perform the emergency stop of the robot 10. The emergency stop request may also be directly input to the robot controller 60. When the robot controller 60 acquires the emergency stop request, the robot controller 60 applies the brake 15 to maintain the posture of the stopped robot 10. Further, the robot controller 60 applies the brake 15 to maintain the posture of the stopped robot 10 when detecting an abnormality of the robot 10, such as a collision between the robot 10 and surrounding objects. When performing an emergency stop of the robot 10, the robot controller 60 not only applies the brake 15 but also stops supply of power to the plurality of joint shafts 12. The robot controller 60 may be configured such that a time from start of a stopping operation to completion of the stopping operation when the velocity becomes zero in the case of performing a temporary stop of the robot 10 is longer than a time from start of a stopping operation to completion of the stopping operation when the velocity becomes zero in the case of performing an emergency stop of the robot 10. In this case, when performing a temporary stop of the robot 10, the robot 10 can be stopped over a relatively long period of time so that loads applied to the joint shafts 12 are reduced when stopping the robot 10. Further, when performing an emergency stop of the robot 10, the robot 10 can be stopped quickly in a relatively short period of time.

### Control Processing of Robot System

With reference to a flowchart of FIG. 6, control processing of the robot system 100 according to this embodiment is described.

As shown in FIG. 6, in step S1, the robot controller 60 controls the joint shafts 12 by torque control. In step S2, the robot controller 60 determines whether a temporary stop request is received from the input terminal 50. When it is determined that no temporary stop request is received from the input terminal 50, the flow proceeds to step S1. Then, the processing of steps S1 and S2 is repeated. While the processing of steps S1 and S2 is repeated, the conveying operation of the workpiece W by the robot 10 is performed as usual. When it is determined that the temporary stop request is received from the input terminal 50, the flow proceeds to step S3.

Then, in step S3, the robot controller 60 switches control of the joint shafts 12 from torque control to velocity control. Then, in step S4, the robot controller 60 decelerates the joint shafts 12 by velocity control. Then, in step S5, the robot controller 60 performs control to maintain the posture of the stopped robot 10 by setting command values of velocity control to zero. In this case, the robot controller 60 performs control to maintain both a released state of the brake 15 and a state in which power is supplied to the joint shafts 12. Further, the robot controller 60 transmits, to the input terminal 50, torque values of the joint shafts 12 in a state in which the posture of the stopped robot 10 is maintained. When restarting operation of the robot 10, the user can cause the display 53 of the input terminal 50 to display the torque values of the joint shafts 12 in a state in which the posture of the stopped robot 10 is maintained, and can check the displayed torque values.

### Advantages of the Embodiment

In this embodiment, the following advantages are obtained.

In the present embodiment, as described above, the robot controller 60, when stopping the robot 10, switches control of the joint shafts 12 from torque control to velocity control and decelerates the joint shafts 12 by the velocity control to hold command values of the velocity control at zero so as to maintain a posture of the stopped robot 10. Accordingly, since the robot 10 can be stopped while torque is generated in the joint shafts 12, a user can grasp a torque value of the joint shafts 12 when the robot 10 is stopped. As a result, the user can grasp a command value for torque control to be input when restarting operation of the robot 10 by torque control, and does not need to calculate the command value for torque control to be input when restarting operation of the robot 10 by torque control. Therefore, it is possible to smoothly restart operation of the robot 10 by torque control after the robot 10 controlled by torque control has been stopped.

Further, in this embodiment, as described above, in a state in which the posture of the stopped robot 10 is maintained by holding command values of the velocity control at zero, when receiving an input of command values of torque control for the plurality of joint shafts 12 for restarting operation of the robot 10, the robot controller 60 switches control of the joint shafts 12 from velocity control to torque control so as to restart operation of the robot 10. Accordingly, after the user inputs command values of torque control, control of the joint shafts 12 is automatically switched from velocity control to torque control, thereby smoothly restarting operation of the robot 10 by torque control.

Further, in this embodiment, as described above, the robot 10 includes the brake 15 arranged at each of the joint shafts 12, and the robot controller 60 maintains the brake 15 in a released state while maintaining the posture of the stopped robot 10 by holding the command values of the velocity control at zero. Accordingly, since the user does not need to release the brake 15 when restarting operation of the robot 10 by torque control, it is possible to smoothly restart operation of the robot 10 by torque control.

Further, in this embodiment, as described above, the robot controller 60 maintains a state in which power is supplied to the joint shafts 12 while maintaining the posture of the stopped robot 10 by holding command values of the velocity control at zero. Accordingly, since the user does not need to perform an operation of supplying electric power to the plurality of joint shafts 12 when restarting operation of the robot 10 by torque control, it is possible to smoothly restart operation of the robot 10 by torque control.

Further, in this embodiment, as described above, the robot controller 60 provides torque values of the joint shafts 12 in a state in which the posture of the stopped robot 10 is maintained by holding command values of the velocity control at zero. Accordingly, the user can easily grasp command values for torque control to be input when restarting operation of the robot 10 by torque control based on the provided torque values.

Further, in the robot 10 according to this embodiment, as described above, the robot arm 11 includes a plurality of joint shafts 12 as drive shafts, and the robot controller 60 performs control to maintain a posture of the stopped robot 10 by holding command values of velocity control for the joint shafts 12 at zero. Accordingly, even in the case of the robot 10 in which command values for torque control are input for the plurality of joint shafts 12, it is possible to smoothly restart operation of the robot 10 by torque control.

Further, in this embodiment, as described above, the robot 10 includes the brake 15 arranged at each of the joint shafts 12, and, when performing a temporary stop of the robot 10, the robot controller 60 maintains the posture of the stopped robot 10 by holding command values of velocity control at zero without applying the brake 15, and, when performing an emergency stop of the robot 10, applies the brake 15 to maintain the posture of the stopped robot 10. Accordingly, when performing a temporary stop of the robot 10, since the robot controller maintains the posture of the stopped robot 10 by holding command values of velocity control at zero without applying the brake 15, it is possible to smoothly restart operation of the robot 10 by torque control. Further, when performing an emergency stop of the robot 10, the posture of the stopped robot 10 can be reliably maintained by maintaining the posture of the stopped robot 10 while applying the brake 15.

### Modified Embodiments

Note that the embodiment disclosed this time must be considered as illustrative in all points and not restrictive. The scope of the present disclosure is not shown by the above description of the embodiments but by the scope of claims for patent, and all modifications (modified embodiments) within the meaning and scope equivalent to the scope of claims for patent are further included.

While the example in which the robot 10 is described as a logistics robot has been shown in the aforementioned embodiment, the present disclosure is not limited to this. In the present disclosure, the robot is not particularly limited as long as the robot is controlled by torque control. For example, the robot may be a robot other than a logistics robot, such as a social robot or a medical robot.

Further, while the example in which the robot 10 is a vertical multi-joint robot has been shown in the aforementioned embodiment, the present disclosure is not limited to this. In the present disclosure, the robot may be a robot other than a vertical multi-joint robot, such as a horizontal multi-joint robot, a cylindrical coordinate robot, a Cartesian coordinate robot, or a dual-arm robot.

Further, while the example in which the robot 10 includes a plurality of joint shafts 12, which are rotational joints, has been shown in the aforementioned embodiment, the present disclosure is not limited to this. In the present disclosure, the robot may have a plurality of joint shafts including both linear and rotational joints, or may have a plurality of joint shafts, which are linear joints. Further, the robot may have drive shafts other than joint shafts.

Further, while the example in which the robot controller 60 controls a plurality of joint shafts 12 has been shown in the aforementioned embodiment, the present disclosure is not limited to this. In the present disclosure, the robot controller may control an external shaft. That is, the robot system may include an external shaft that is cooperatively controlled with the plurality of joint shafts, and the controller is configured to, when stopping the robot, switch control of both the joint shafts and the external shaft from the torque control to the velocity control, decelerate both the joint shafts and the external shaft by the velocity control, and hold command values of the velocity control for both the joint shafts and the external shaft at zero. Accordingly, similar to the case of the plurality of joint shafts, the user can easily grasp command values for torque control to be input when restarting operation of the external shaft by torque control. As a result, it is possible to smoothly restart operation of the robot and the external shaft by torque control after the robot and the external shaft controlled by torque control have been stopped.

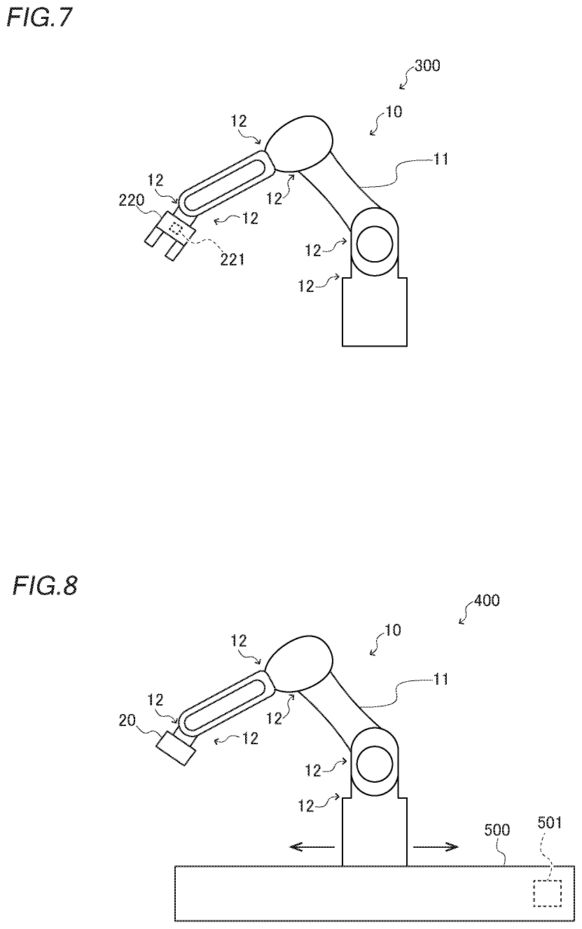

A robot system 300 according to a modified embodiment shown in FIG. 7 includes an external shaft 221 that is cooperatively controlled with a plurality of joint shafts 12 by the robot controller 60. Further, the robot system 300 includes an end effector 220 arranged on the robot 10. The external shaft 221 is arranged on the end effector 220. Accordingly, in the robot system 300 including the external shaft 221 arranged on the end effector 220, operation of the robot 10 and the external shaft 221 by torque control can be smoothly resumed. The external shaft 221 includes a servo motor, an encoder, and a brake, and can be controlled in the same manner as the joint shafts 12 in the aforementioned embodiment.

A robot system 400 according to a modified embodiment shown in FIG. 8 includes an external shaft 501 that is cooperatively controlled with a plurality of joint shafts 12 by the robot controller 60. Further, the robot system 400 includes a position changer 500 configured to change a position of the robot 10. The external shaft 501 is arranged on the position changer 500. Accordingly, in the robot system 400 including the external shaft 501 arranged on the position changer 500, operation of the robot 10 and the external shaft 501 by torque control can be smoothly resumed. Although the position changer 500 in the modified embodiment shown in FIG. 8 is a linear motion mechanism that linearly moves the robot 10, the position changer may be a rotation mechanism that rotationally moves the robot 10. Further, the external shaft 501 includes a servo motor, an encoder, and a brake, and can be controlled in the same manner as the joint shafts 12 in the aforementioned embodiment. Further, the robot system may include both the external shaft arranged on the end effector and the external shaft arranged on the position changer.

Further, while the example in which the program 65 is stored in the storage 64 of the robot controller 60 has been shown in the aforementioned embodiment, the present disclosure is not limited to this. In the present disclosure, the program may be stored in a storage of an external PC externally connected to the robot controller, a storage of an external control device, a storage of a host controller, or the like.

Functions of elements disclosed in this specification can be realized by a circuit or processing circuit including a general purpose processor, a dedicated processor, an integrated circuit, ASIC (Application Specific Integrated Circuits), a conventional circuit and/or combination of them configured or programmed to realize the disclosed functions. A processor is considered a processing circuit or circuits because it contains transistors and other circuitry. In the present disclosure, a circuit, a unit, or a means is hardware that performs an enumerated function or is hardware programmed to perform an enumerated function. The hardware may be the hardware disclosed herein or any other known hardware that is programmed or configured to perform the enumerated functions. When the hardware is a processor, which is considered a type of circuit, the circuit, means, or unit is a combination of hardware and software, and software is used to configure the hardware and/or processor.

### EMBODIMENTS

The aforementioned exemplary embodiment will be understood as concrete examples of the following Embodiments by those skilled in the art.

### Embodiment 1

A robot system includes a robot including a drive shaft; and a controller configured to control the robot, wherein the controller is configured to, when operating the robot, control the drive shaft by torque control, and, when stopping the robot, switch control of the drive shaft from the torque control to velocity control and decelerate the drive shaft by the velocity control to hold a command value of the velocity control at zero so as to maintain a posture of the stopped robot.

### Embodiment 2

In the robot system according to Embodiment 1, the controller is configured to, in a state in which the posture of the stopped robot is maintained by holding the command value of the velocity control at zero, when receiving an input of a command value of the torque control for the drive shaft for restarting operation of the robot, switch control of the drive shaft from the velocity control to the torque control so as to restart the operation of the robot.

### Embodiment 3

In the robot system according to Embodiment 1 or 2, the robot includes a brake disposed on the drive shaft; and the controller is configured to maintain the brake in a released state while maintaining the posture of the stopped robot by holding the command value of the velocity control at zero.

### Embodiment 4

In the robot system according to any one of Embodiments 1 to 3, the controller is configured to perform control to maintain a state in which power is supplied to the drive shaft while maintaining the posture of the stopped robot by holding the command value of the velocity control at zero.

### Embodiment 5

In the robot system according to any one of Embodiments 1 to 4, the controller is configured to perform control to provide a torque value of the drive shaft in a state in which the posture of the stopped robot is maintained by holding the command value of the velocity control at zero.

### Embodiment 6

In the robot system according to any one of Embodiments 1 to 5, the robot includes a robot arm having a plurality of joint shafts as drive shafts, and the controller is configured to maintain the posture of the stopped robot by holding the command value of the velocity control for each of the joint shafts at zero.

### Embodiment 7

In the robot system according to Embodiment 6, the controller is configured to maintain the posture of the stopped robot by holding command values of the velocity control for all of the joint shafts at zero.

### Embodiment 8

In the robot system according to any one of Embodiments 1 to 7, the robot includes a brake disposed on the drive shaft; and the controller is configured to, when performing a temporary stop of the robot, maintain the posture of the stopped robot by holding the command value of the velocity control at zero without applying the brake, and, when performing an emergency stop of the robot, apply the brake to maintain the posture of the stopped robot.

### Embodiment 9

In the robot system according to any one of Embodiments 1 to 8, the robot system further includes an external shaft that is cooperatively controlled with the drive shaft, and the controller is configured to, when stopping the robot, switch control of the drive shaft and the external shaft from the torque control to the velocity control, decelerate the drive shaft and the external shaft by the velocity control, and hold command values of the velocity control for the drive shaft and the external shaft at zero.

### Embodiment 10

In the robot system according to Embodiment 9, the robot system further includes an end effector disposed on the robot, and the external shaft is disposed on the end effector.

### Embodiment 11

In the robot system according to Embodiment 9 or 10, the robot system further includes a position changer configured to change a position of the robot, and the external shaft is disposed on the position changer.

### Embodiment 12

In the robot system according to Embodiment 1, the controller is configured to control the drive shaft by the torque control when the robot performs a conveying operation of a workpiece.

### Embodiment 13

A method for controlling a robot system, the method includes controlling a drive shaft of a robot by torque control when operating the robot; switching control of the drive shaft from the torque control to velocity control when stopping the robot; and decelerating the drive shaft by the velocity control and maintaining a posture of the stopped robot by holding a command value of the velocity control at zero.

### Embodiment 14

A storage medium for storing a program for controlling a robot system that causes a computer to execute processing for controlling a drive shaft of a robot by torque control when operating the robot; processing for switching control of the drive shaft from the torque control to velocity control when stopping the robot; and processing for decelerating the drive shaft by the velocity control and maintaining a posture of the stopped robot by holding a command value of the velocity control at zero.

What is claimed is:

1. A robot system comprising:
a robot including a drive shaft; and
a controller configured to control the robot, wherein
the controller is configured to, when operating the robot, control the drive shaft by torque control, and, when stopping the robot, switch control of the drive shaft from the torque control to velocity control and decelerate the drive shaft by the velocity control to hold a command value of the velocity control at zero so as to maintain a posture of the stopped robot.

2. The robot system according to claim 1, wherein the controller is configured to, in a state in which the posture of the stopped robot is maintained by holding the command value of the velocity control at zero, when receiving an input of a command value of the torque control for the drive shaft for restarting operation of the robot, switch control of the drive shaft from the velocity control to the torque control so as to restart the operation of the robot.

3. The robot system according to claim 1, wherein
the robot includes a brake disposed on the drive shaft; and
the controller is configured to maintain the brake in a released state while maintaining the posture of the stopped robot by holding the command value of the velocity control at zero.

4. The robot system according to claim 1, wherein the controller is configured to perform control to maintain a state in which power is supplied to the drive shaft while maintaining the posture of the stopped robot by holding the command value of the velocity control at zero.

5. The robot system according to claim 1, wherein the controller is configured to perform control to provide a torque value of the drive shaft in a state in which the posture of the stopped robot is maintained by holding the command value of the velocity control at zero.

6. The robot system according to claim 1, wherein
the robot includes a robot arm having a plurality of joint shafts as drive shafts, and
the controller is configured to maintain the posture of the stopped robot by holding the command value of the velocity control for each of the joint shafts at zero.

7. The robot system according to claim 6, wherein the controller is configured to maintain the posture of the stopped robot by holding command values of the velocity control for all of the joint shafts at zero.

8. The robot system according to claim 1, wherein
the robot includes a brake disposed on the drive shaft; and
the controller is configured to, when performing a temporary stop of the robot, maintain the posture of the stopped robot by holding the command value of the velocity control at zero without applying the brake, and, when performing an emergency stop of the robot, apply the brake to maintain the posture of the stopped robot.

9. The robot system according to claim 1, further comprising an external shaft that is cooperatively controlled with the drive shaft, wherein
the controller is configured to, when stopping the robot, switch control of the drive shaft and the external shaft from the torque control to the velocity control, decelerate the drive shaft and the external shaft by the velocity control, and hold command values of the velocity control for the drive shaft and the external shaft at zero.

10. The robot system according to claim 9, further comprising an end effector disposed on the robot, wherein
the external shaft is disposed on the end effector.

11. The robot system according to claim 9, further comprising a position changer configured to change a position of the robot, wherein
the external shaft is disposed on the position changer.

12. The robot system according to claim 1, wherein the controller is configured to control the drive shaft by the torque control when the robot performs a conveying operation of a workpiece.

13. A method for controlling a robot system, the method comprising:
controlling a drive shaft of a robot by torque control when operating the robot;
switching control of the drive shaft from the torque control to velocity control when stopping the robot; and
decelerating the drive shaft by the velocity control and maintaining a posture of the stopped robot by holding a command value of the velocity control at zero.

14. A storage medium for storing a program for controlling a robot system that causes a computer to execute:
processing for controlling a drive shaft of a robot by torque control when operating the robot;
processing for switching control of the drive shaft from the torque control to velocity control when stopping the robot; and
processing for decelerating the drive shaft by the velocity control and maintaining a posture of the stopped robot by holding a command value of the velocity control at zero.
